(19) United States
(12) Patent Application Publication
(10) Pub. No.: US 2015/0180717 A1
(43) Pub. Date: Jun. 25, 2015

(54) CONFIGURING VIRTUAL ROUTER REDUNDANCY PROTOCOL BACKUP GROUP

(71) Applicant: Hangzhou H3TC Technologies Co., Ltd., Hangzhou Zheijiang (CN)

(72) Inventor: Xiaohui Cui, Beijing (CN)

(73) Assignee: Hangzhou H3C Technologies Co., Ltd, Hangzhou (CN)

(21) Appl. No.: 14/372,725

(22) PCT Filed: Jun. 6, 2013
(86) PCT No.: PCT/CN2013/076859

§ 371 Date: Jul. 16, 2014

(30) Foreign Application Priority Data
Jul. 24, 2012 (CN) 201210256973.2

(51) Int. Cl. H04L 12/24; H04L 12/931; H04L 29/12; H04L 12/713

(52) U.S. Cl. CPC H04L 41/0846; H04L 41/0836; H04L 45/586; H04L 49/70; H04L 61/2061

(57) ABSTRACT

According to an example, when a member device is in a Master state in a VRRP backup group, after snooping a first DHCP packet sent from a DHCP client to a DHCP server, the member device determines an interface receiving the first DHCP packet as an interface of the DHCP client; after snooping a second DHCP packet sent from the DHCP server to a DHCP client, the member device obtains a default gateway address and a subnet mask of the DHCP client from the second DHCP packet; after obtaining the default gateway address and the subnet mask, if the interface of the DHCP client is not configured with a virtual IP address and a network segment route, the member device respectively configures the default gateway address and the subnet mask as the virtual IP address and the network segment route on the interface of the DHCP client.

### BACKGROUND OF THE INVENTION

By using a Virtual Router Redundancy Protocol (VRRP), multiple routing devices working as a gateway in a local area network may join a VRRP backup group and form a virtual routing device. Each routing device in the VRRP backup group is called a member device of the VRRP backup group, but only a member device in a Master state is able to forward traffic by using a virtual IP address and a network segment route of a network segment in the local area network.

### BRIEF DESCRIPTION OF THE DRAWINGS

FIGS. 1a and 1b are schematic diagrams illustrating two networking modes for implementing examples of the present disclosure.

FIG. 2 is a schematic flowchart illustrating a method for configuring a VRRP backup group in accordance with an example of the present disclosure.

FIG. 3 is a schematic flowchart illustrating a method for configuring a VRRP backup group in accordance with another example of the present disclosure.

FIG. 4 is a schematic diagram illustrating an apparatus for configuring a VRRP backup group in accordance with an example of the present disclosure.

FIG. 5 is a schematic diagram illustrating an apparatus for configuring a VRRP backup group in accordance with another example of the present disclosure.

FIG. 6 is a schematic diagram illustrating two examples of the present disclosure.

### DETAILED DESCRIPTION

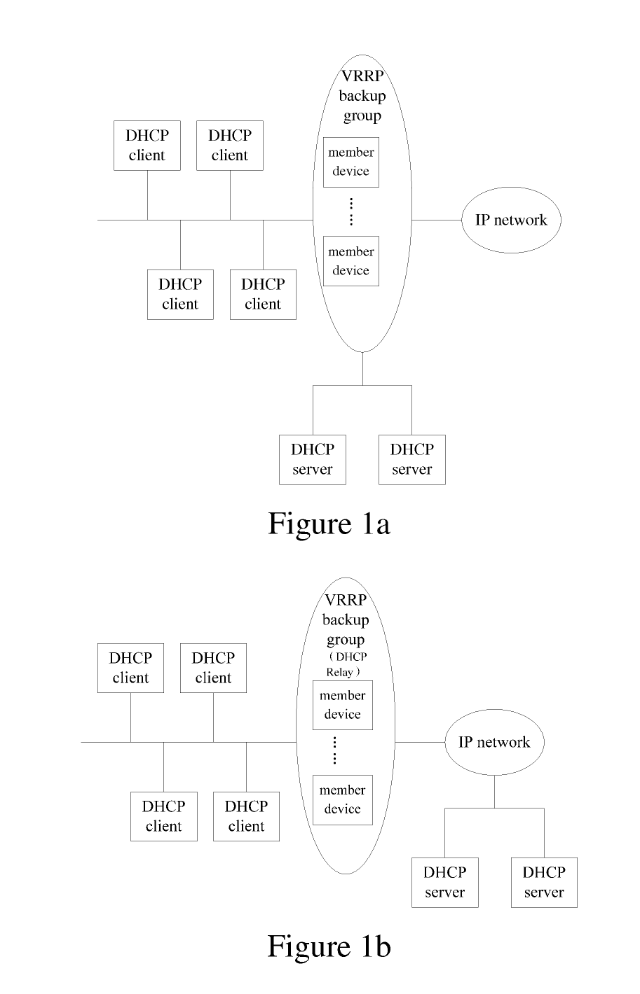

In order to make the purpose, solutions and merit more clear, the present disclosure is illustrated in detail hereinafter with reference to the accompanying drawings and specific examples. FIGS. 1a and 1b are schematic diagram illustrating two networking modes for implementing examples of the present disclosure. In FIG. 1a, a Dynamic Host Configuration Protocol (DHCP) server, a VRRP backup group and a DHCP client are located at the same local area network; in FIG. 1b, a DHCP server, a VRRP backup group and a DHCP client are located at different local area networks, and each member device of the VRRP backup group needs to be configured with a DHCP Relay function. As shown in FIGS. 1a and 1b, no matter whether the DHCP server is located at the same local area network with the VRRP backup group and the DHCP client, when a default gateway address and a subnet mask are applied from the DHCH server, all DHCP packets are forwarded via a member device in a Master state in the VRRP backup group.

In a DHCP procedure, the DHCP packets at least include:

a DISCOVER packet, which is used for discovering the DHCP server and is broadcasted by the DHCP client to each DHCP server;

an OFFER packet, which is used for responding to the discovery of the DHCP server and is broadcasted by the DHCP server to each DHCP client or is unicasted by the DHCP server to a designated DHCP client (the DHCP client broadcasting the DISCOVER packet);

a REQUEST packet, which is used for selecting a DHCP server and applying an address and is broadcasted by the DHCP client to each DHCP server;

an ACK packet, which is used for assigning the address and is broadcasted by the DHCP server to the designated DHCP client (the DHCP client selecting the DHCP server via broadcasting the REQUEST packet), the ACK packet using a broadcasting IP address and indicating the DHCP client corresponding to the assigned address via a MAC address;

a REQUEST packet, which is used for applying for renewal and is unicasted by the DHCP client to a designated DHCP server (the DHCP server unicasting the ACK packet to the DHCP client);

an ACK packet, which is used for allowing the renewal and is unicasted by the DHCP server to a designated DHCP client (the DHCP client selecting the DHCP server via unicasting the REQUEST packet);

a DECLINE packet, which is used for refusing address assignment and is unicasted by the DHCP client to a designated DHCP server (the DHCP server unicasting or broadcasting the ACK packet to the DHCP client);

a RELEASE packet, which is used for releasing an address and is unicasted by the DHCP client to a designated DHCP server (the DHCP server unicasting or broadcasting the ACK packet to the DHCP client).

Some of the above-mentioned DHCP packets may be used for identifying the DHCP client, e.g. the DISCOVER packet and the REQUEST packet. In the examples of the present disclosure, the DHCP packet that can be used for identifying the DHCP client is called a first DHCP packet;

In addition, some of the above-mentioned DHCP packets carry the default gateway address and subnet mask assigned by the DHCP server for the DHCP client, e.g. the ACK packet. In the examples of the present disclosure, the DHCP packet carrying the default gateway address and subnet mask is called a second DHCP packet.

In the VRRP backup group, the member device in the Master state snoops the first and second DHCP packets, determines an interface of each is DHCP client (the “interface” in the present disclosure refers to a layer 3 interface in the Open Systems Interconnection (OSI) model, which may be a virtual interface in logic), and obtains the default gateway address and subnet mask assigned by the DHCP server for each DHCP client according to the second DHCP packet.

Because the virtual IP address and network segment route configured in the VRRP backup group are to match the default gateway address and subnet mask used by the DHCP client in each network segment, the member device in the Master state in the VRRP backup group may configure the virtual IP address and network segment route on the interface of each DHCP client for the network segment of the DHCP client, according to the obtained default gateway address and the subnet mask.

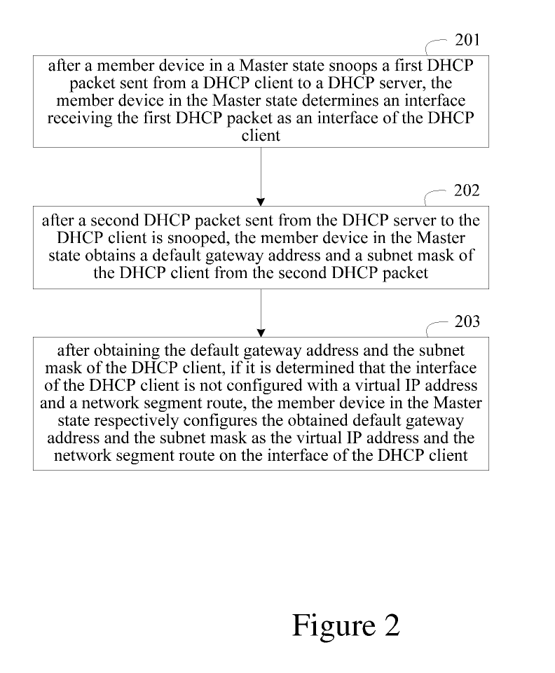

FIG. 2 is a schematic flowchart illustrating a method for configuring a VRRP backup group in accordance with an example of the present disclosure. As shown in FIG. 2, the method includes the following operations.

In block 201, in a VRRP backup group, after a member device in a Master state snoops a first DHCP packet sent from a DHCP client to a DHCP server, the member device in the Master state determines an interface receiving the first DHCP packet as an interface of the DHCP client.

In block 202, after a second DHCP packet sent from the DHCP server to a DHCP client is snooped, the member device in the Master state obtains a default gateway address and a subnet mask of the DHCP client from the second DHCP packet.

In block 203, after obtaining the default gateway address and the subnet mask of the DHCP client, if it is determined that the interface of the DHCP client is not configured with a virtual IP address and a network segment route, the member device in the Master state respectively configures the obtained default gateway address and the subnet mask as the virtual IP address and the network segment route on the interface of the DHCP client, and the procedure is terminated.

The procedure of determining whether the interface of the DHCP client is configured with the virtual IP address and the network segment route may include: according to a client ID in the second DHCP packet, determining a DHCP client corresponding to the client ID, searching for a stored interface of the DHCP client, and then determining whether the interface of the DHCP client is configured with the virtual IP address and network segment route.

For each member device in the VRRP backup group, the above procedure is performed when the member device is in the Master state. Therefore, for the VRRP backup group, the above procedure may be regarded as being performed within the member device in the Master state in the VRRP backup group. Further, the above procedure may be repeatedly performed for different DHCP clients.

As can be seen, according to the method for configuring the VRRP backup group provided by the examples of the present disclosure, each member device in the VRRP backup group may automatically generate the virtual IP address and network segment route via snooping the first and second packets when the member device is in the Master state, so that the virtual IP address and network segment route are configured automatically which reduces the burden on the network administrator as it is unnecessary to manually configure each member device in the VRRP backup group. Further, when the network segment in the local area network changes after the networking is finished, each member device in the VRRP backup group may perceive the change of the network segment via snooping the DHCP packet when the member device is in the Master state, and generate the virtual IP address and network segment route according to the change of the network segment, which can further reduce the burden on the network administrator.

Usually, the default gateway address and the subnet mask assigned by the DHCP server for each DHCP client are valid in a certain lease length. The is second DHCP packet carries the lease length assigned by the DHCP server for the DHCP client.

Accordingly, in the examples of the present disclosure, a lifetime of the virtual IP address and network segment route which are configured for the interface of each DHCP client is maintained by using the lease length of the DHCP client. When multiple DHCP clients corresponding to the same interface use the same virtual IP address and network segment route, the lifetime may be maintained by using the lease length of each DHCP client using the same virtual IP address and network segment route, so that the lifetime of the shared virtual IP address and network segment route corresponds to the longest lease length.

In this way, when the lease lengths of all DHCP clients corresponding to the same interface expire and no renewal is performed, the lifetime of the virtual IP address and network segment route which are configured for the interface expires, and thus the virtual IP address and the network segment route are cancelled.

Besides the limitation of the lease length, the DHCP client may no longer use the default gateway address and subnet mask voluntarily, e.g. when the DHCP client logs off, the default gateway address and subnet mask assigned by the DHCP server are not used by the DHCP client any more.

Correspondingly, some DHCP packets forwarded via the VRRP backup group may indicate that the DHCP client can no longer use the default gateway address and subnet mask, e.g. the DECLINE packet and RELEASE packet. This type of packets is called a third DHCP packet.

According to an example, when the third DHCP packets sent to the DHCP server by all of the DHCP clients using the same virtual IP address and the network segment route have been snooped via the interface, the virtual IP address and the network segment route configured for the interface are cancelled. The number of the third packets may be counted to determine whether all of the DHCP clients using the same virtual IP address and the network segment route have sent the third DHCP packet to the DHCP server.

In addition, after the lifetime is updated according to the longest lease length for all DHCP clients using the same virtual IP address and network segment router, if the DHCP client with the longest lease length no longer uses the default gateway address and subnet mask assigned by the DHCP server via sending the third DHCP packet, the lifetime does not correspond to the longest lease length of the rest DHCP clients.

According to an example, client state information may be maintained for each DHCP client, and whether to cancel the virtual IP address and the network segment route may be determined according to the client state information of the client.

Specifically, after obtaining the default gateway address, the subnet mask and the lease length of the DHCP client, the member device stores the lease length of the DHCP client, stores that the DHCP client is in a logoff state when the lease length expires and no renewal is performed; or stores that the DHCP client is in a logoff state when the third DHCP packet sent to the DHCP server from the DHCP client is snooped.

When the member device is in the Master state, if it is determined that all of the DHCP clients using the same virtual IP address and network segment route are in the logoff state, the virtual IP address and network segment route are cancelled.

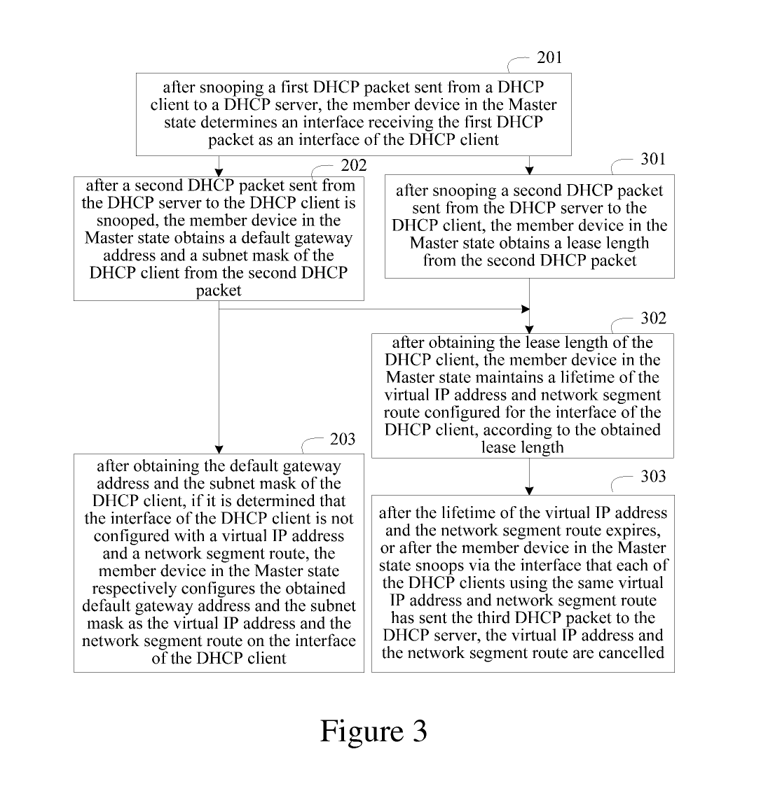

FIG. 3 is a schematic flowchart illustrating a method for configuring a VRRP backup group in accordance with another example of the present disclosure. Steps 201-203 are the same as shown in FIG. 2.

In block 201, after a member device in a Master state snoops a first to DHCP packet sent from a DHCP client to a DHCP server, the member device in the Master state determines an interface receiving the first DHCP packet as an interface of the DHCP client, and then block 202 and block 301 are performed.

In block 202, after a second DHCP packet sent from the DHCP server to a DHCP client is snooped, the member device in the Master state obtains a default gateway address and a subnet mask of the DHCP client from the second DHCP packet, and then block 203 is performed.

In block 203, after obtaining the default gateway address and the subnet mask of the DHCP client, if it is determined that the interface of the DHCP client is not configured with a virtual IP address and a network segment route, the member device in the Master state respectively configures the obtained default gateway address and the subnet mask as the virtual IP address and the network segment route on the interface of the DHCP client, and the procedure is terminated.

In block 301, after the member device in the Master state snoops a second DHCP packet sent from the DHCP server to the DHCP client, the member device in the Master state obtains a lease length from the second DHCP packet, and then block 302 is performed.

In block 302, after obtaining the default gateway address, the subnet mask and the lease length of the DHCP client, the member device in the Master state maintains a lifetime of the virtual IP address and network segment route configured for the interface of the DHCP client, according to the obtained lease length, and then block 303 is performed.

The blocks 301 and 302 may be repeatedly performed for each DHCP client.

If the blocks 301 and 302 are performed for a certain DHCP client for the first time, i.e., the second DHCP packet snooped in the block 301 is a response sent by the DHCP server when the DHCP client applied for the first time. Correspondingly, the interface of the DHCP client is just configured with the virtual IP address and the network segment route via the blocks 202 and 203, and the lifetime is not configured for the interface of the DHCP client. In this case, the maintaining in this block refers to establishing a lifetime for the virtual IP address and network segment route configured for the interface of the DHCP client according to the obtained lease length.

If the blocks 301 and 302 are not performed for the DHCP client for the first time, i.e., the second DHCP packet snooped in the block 301 is a response sent by the DHCP server for a renewal application of the DHCP client. Correspondingly, the interface of the DHCP client has been configured with the lifetime for the virtual IP address and the network segment route. In this case, the maintaining in this block refers to maintaining a lifetime for the virtual IP address and network segment route configured for the interface of the DHCP client according to the obtained lease length. The maintaining may be performed according to lease lengths of different DHCP clients corresponding to the same interface.

In block 303, after the lifetime of the virtual IP address and the network segment route expires, the virtual IP address and the network segment route are cancelled; or after the member device in the Master state snoops via the interface that each of the DHCP clients using the same virtual IP address and network segment route has sent the third DHCP packet to the DHCP server, the virtual IP address and the network segment route are cancelled. The procedure is terminated.

If the member device also maintains the client state information, when determining that each of the DHCP clients using the same virtual IP address and the network segment route on the interface is logoff, the corresponding virtual IP address and network segment route are cancelled via block 303.

For each member device in the VRRP backup group, the above procedure is performed when the member device is in the Master state. Therefore, for the VRRP backup group, the above procedure may be regarded as being performed within a member device in the Master state in the VRRP backup group. Further, the above procedure may be repeatedly performed for different DHCP clients.

As can be seen, according to the method for configuring the VRRP backup group provided by the examples of the present disclosure, when being in the Master state, each member device in the VRRP backup group may obtain the lease length from the snooped second DHCP packet, maintain and cancel the configuration of the interface via snooping the third DHCP packet, thereby ensuring that the configuration of each interface changes with the state of the DHCP client. The first DHCP packet may be the DISCOVER packet broadcasted by the DHCP client to all DHCP servers or the REQUEST packet broadcasted by the DHCP client to all DHCP servers; the second DHCP packet may be the ACK packet broadcasted by the DHCP server to all DHCP clients or the ACK packet unicasted by the DHCP server to a designated DHCP client; the third DHCP packet may be the DECLINE packet or RELEASE packet unicasted by the DHCP client to a designated DHCP server. The first, second and third packets are not limited in the above types of packets and transmission modes.

When at least one of the first, second and third DHCP packets is sent by using a broadcast mode, each member device in the VRRP backup group may receive the at least one of the first, second and third DHCP packets, thereby ensuring that the member device in the Master state may snoop the at least one of the first, second and third DHCP packets.

When at least one of the first, second and third DHCP packets is sent by using a unicast mode, it is hard to determine which member device in the VRRP backup group may receive the at least one of the first, second and third DHCP packets, so that the member device in the Master state may miss the at least one of the first, second and third DHCP packets.

Therefore, for the purpose of ensuring that the member device may snoop the first, second or third DHCP packet, the method for configuring the VRRP backup group shown in FIGS. 2 and 3 may further include packet relocation processing performed for each member device in the VRRP backup group.

When snooping the first, second or third DHCP packet, the member device in the Backup state forwards the snooped first, second or third DHCP packet to the member device in the Master state in the VRRP backup group.

That is, in the VRRP backup group, besides the member device in the Master state performs the procedure shown in the FIGS. 2 and 3, each member device in the Backup state performs the packet relocation processing.

In this way, according to the method for configuring the VRRP backup group provided by the examples of the present disclosure, in the VRRP backup group, the member device in the Backup state sends the snooped first, second or third DHCP packet to the member device in the Master state, so that the member device in the Master state does not miss the first, second or third DHCP packet.

In addition, for the purpose of avoiding the loss of virtual IP address and network segment route caused by switch between the device in the Master state and the device in the Backup state, the method for configuring the VRRP backup group shown in FIGS. 2 and 3 may further include additional processing performed for each member device in the VRRP backup group.

For example, the member device in the Master state notifies other member devices in the Backup state of the virtual IP address and network segment route configured for the interface of each DHCP client and the lifetime maintained for each DHCP client. If the member device in the Master state also maintains the client state information, the client state information does not need to be notified.

Specifically, the member device in the Master state may notify other member devices in the Backup state of the virtual IP address, the network segment route and the lifetime via notification packets of the VRRP. In this case, the member device in the Master state needs to have a function of adding the virtual IP address, the network segment route and the lifetime into the notification packets of the VRRP, and the member device in the Backup state needs to have a function of obtaining the virtual IP address, the network segment route and the lifetime from the notification packets of the VRRP.

The method for configuring the VRRP backup group provided by the examples of the present disclosure may be implemented via computer programs. Correspondingly, also disclosed herein is an apparatus for configuring a VRRP backup group.

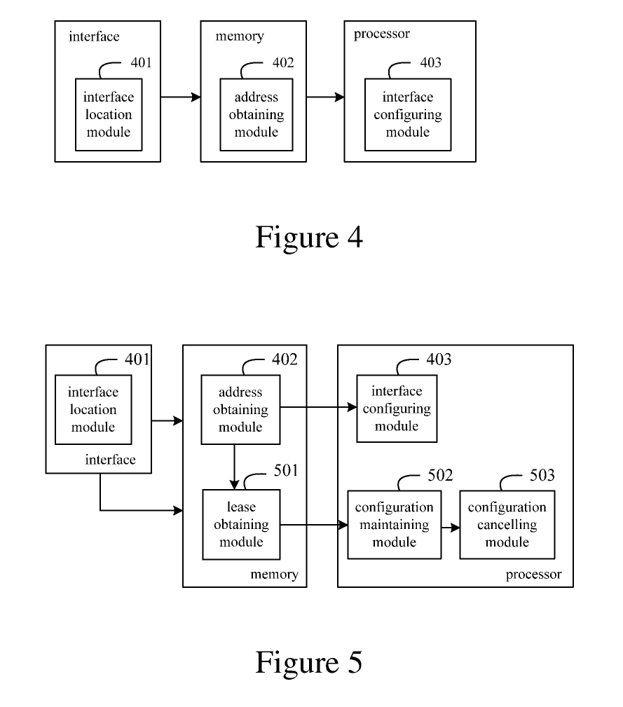

FIG. 4 is a schematic diagram illustrating an apparatus for configuring a VRRP backup group in accordance with an example of the present disclosure. As shown in FIG. 4, the apparatus includes an interface, a memory and a processor. When the apparatus is located in each member device of a VRRP backup group.

the interface includes an interface location module 401; when the member device is in a Master state, the interface location module 401 is to snoop a first DHCP packet sent from a DHCP client to a DHCP server and snoop a second DHCP packet sent from a DHCP server to a DHCP client;

the memory includes an address obtaining module 402; when the member device is in a Master state, the address obtaining module 402 is to determine an interface receiving the first DHCP packet as an interface of the DHCP client, and store a default gateway address and a subnet mask of the DHCP client which are obtained from the second DHCP packet;

the processor includes an interface configuring module 403; when the member device is in a Master state, the interface configuring module 403 is to determine whether the interface of the DHCP client is configured with a virtual IP address and a network segment route, and configure the default gateway address and the subnet mask obtained by the address obtaining module 402 as the virtual IP address and the network segment route on the interface of the DHCP client when the interface of the DHCP client is not configured with a virtual IP address and a network segment route.

The procedure of determining by the interface configuring module 403 whether the interface of the DHCP client is configured with the virtual IP address and the network segment route may include: according to a client ID in the second DHCP packet, determining a DHCP client corresponding to the client ID, searching for a stored interface of the DHCP client, and then determining whether the interface of the DHCP client is configured with the virtual IP address and network segment route.

For each member device in the VRRP backup group, the above procedure is performed when the member device is in the Master state. Therefore, for the VRRP backup group, the above procedure may be regarded as being performed within the member device in the Master state in the VRRP backup group. Further, the above procedure may be repeatedly performed for different DHCP clients.

As can be seen, according to the apparatus for configuring the VRRP backup group provided by the examples of the present disclosure, each member device in the VRRP backup group may automatically generate the virtual IP address and network segment route via snooping the first and second packets when the member device is in the Master state, so that the virtual IP address and network segment route are configured automatically, it is unnecessary to manually configure each member device in the VRRP backup group when networking is performed, and thus the burden of the networking is reduced. Further, when the network segment in the local area network changes after the networking is finished, each member device in the VRRP backup group may perceive the change of the network segment via snooping the DHCP packet when the member device is in the Master state, and generate the virtual IP address and network segment route according to the change of the network segment, so that it is unnecessary to manually change the configuration of the VRRP backup group, and the burden of network maintenance work is reduced.

FIG. 5 is a schematic diagram illustrating an apparatus for configuring a VRRP backup group in accordance with another example of the present disclosure. As shown in FIG. 5, the apparatus includes an interface, a memory and a processor. When the apparatus is located in each member device of a VRRP backup group,

the interface includes an interface location module 401; when the member device is in a Master state, the interface location module 401 is to snoop a first DHCP packet sent from a DHCP client to a DHCP server and snoop a second DHCP packet sent from a DHCP server to a DHCP client;

the memory includes an address obtaining module 402; when the member device is in a Master state, the address obtaining module 402 is to determine an interface receiving the first DHCP packet as an interface of the DHCP client, and store a default gateway address and a subnet mask of the DHCP client which are obtained from the second DHCP packet;

the processor includes an interface configuring module 403; when the member device is in a Master state, the interface configuring module 403 is to determine whether the interface of the DHCP client is configured with a virtual IP address and a network segment route, and configure the default gateway address and the subnet mask obtained by the address obtaining module 402 as the virtual IP address and the network segment route on the interface of the DHCP client when the interface of the DHCP client is not configured with a virtual IP address and a network segment route.

According to an example, the memory further includes a lease obtaining module 501, and the processor further includes a configuration maintaining module 502 and a configuration cancelling module 503.

When the member device is in the Master state, the lease obtaining module 501 is to store a lease length of the DHCP client obtained from the second DHCP packet after the address obtaining module snoops the second DHCP packet. When the member device is in the Master state, the configuration maintaining module 502 is to maintain a lifetime of the virtual IP address and network segment route configured for the interface of the DHCP client according to the obtained lease length. When multiple DHCP clients corresponding to the same interface use the same virtual IP address and network segment route, the lifetime may be maintained by using the lease length of each DHCP client using the same virtual IP address and network segment route, so that the lifetime of the shared virtual IP address and network segment route corresponds to the longest lease length.

The lease obtaining module 501 and the configuration maintaining module 502 may be repeatedly triggered for the DHCP clients.

If the lease obtaining module 501 and the configuration maintaining module 502 are triggered for a certain DHCP client for the first time, i.e., the second DHCP packet snooped by the lease obtaining 501 is a response sent by the DHCP server when the DHCP client applied for the first time. Correspondingly, the interface of the DHCP client is just configured with the virtual IP address and the network segment route via the address obtaining module 401 and the interface configuration module 402, and the lifetime is not configured for the interface of the DHCP client. In this case, the maintaining performed by the configuration maintaining module 502 refers to establishing a lifetime for the virtual IP address and network segment route configured for the interface of the DHCP client according to the lease length obtained by the lease obtaining 501.

If the lease obtaining module 501 and the configuration maintaining module 502 are not triggered for the DHCP client for the first time, i.e., the second DHCP packet snooped by the lease obtaining module 501 is a response sent by the DHCP server for a renewal application of the DHCP client. Correspondingly, the interface of the DHCP client has been configured with the lifetime for the virtual IP address and the network segment route. In this case, the maintaining performed by the configuration maintaining module 502 refers to maintaining a lifetime for the virtual IP address and network segment route configured for the interface of the DHCP client according to the lease length obtained by the lease obtaining module 501. The maintaining may be performed according to lease lengths of different DHCP clients corresponding to the same interface.

The configuration cancelling module 503 is to cancel the virtual IP address and the network segment route after the lifetime of the virtual IP address and the network segment route expires; or to cancel the virtual IP address and the network segment route after the member device in the Master state snoops via the interface that each of the DHCP clients using the same virtual IP address and network segment route has sent the third DHCP packet to the DHCP server.

In addition, the memory in the apparatus may further include a state maintaining module (not shown in FIG. 5), after the default gateway address, the subnet mask and the lease length of the DHCP client are obtained, the state maintaining module is to store the lease length of the DHCP client, store that the DHCP client is in a logoff state when the lease length expires and no renewal is performed; or store that the DHCP client is in a logoff state when the third DHCP packet sent to the DHCP server from the DHCP client is snooped by the member device in the Master state.

Correspondingly, the configuration cancelling module 503 in the processor is further to cancel the virtual IP address and network segment route when the member device in the Master state determines that all of the DHCP clients using the same virtual IP address and network segment route are in the logoff state.

For each member device in the VRRP backup group, the above modules are triggered when the member device is in the Master state. Therefore, for the VRRP backup group, the above modules may be regarded as being triggered within a member device in the Master state in the VRRP backup group. Further, the above modules may be repeatedly triggered for different DHCP clients.

As can be seen, according to the apparatus for configuring the VRRP backup group provided by the examples of the present disclosure, when being in the Master state, each member device in the VRRP backup group may obtain the lease length from the snooped second DHCP packet, maintain and cancel the configuration of the interface via snooping the third DHCP packet, thereby ensuring that the configuration of each interface changes with the state of the DHCP client. In addition, because the sending modes of the first, second, and third DHCP packets include a broadcast mode and a unicast mode, the following modules are configured in the processor shown in FIGS. 4 and 5.

A packet relocation module is to snoop the first, second or third DHCP packet, and to forward the snooped first, second or third DHCP packet to the member device in the Master state in the VRRP backup group.

That is, in the VRRP backup group, besides the modules shown in the FIG. 4 or 5 are triggered in the member device in the Master state, the packet relocation module is triggered in each member devices in the Backup state.

In this way, according to the apparatus for configuring the VRRP backup group provided by the examples of the present disclosure, in the VRRP backup group, the member device in the Backup state sends the snooped first, second or third DHCP packet to the member device in the Master state, so that the member device in the Master state does not miss the first, second or third DHCP packet.

In addition, for the purpose of avoiding the loss of virtual IP address and network segment route caused by switch between the device in the Master state and the device in the Backup state, the processor shown in FIG. 4 or 3 may further include an in-group notifying module (no shown in FIGS. 4 and 5). When the member device is in the Master state, the in-group notifying module is to notify other member devices in the Backup state of the virtual IP address and network segment route configured for the interface of each DHCP client and the lifetime maintained for each DHCP client.

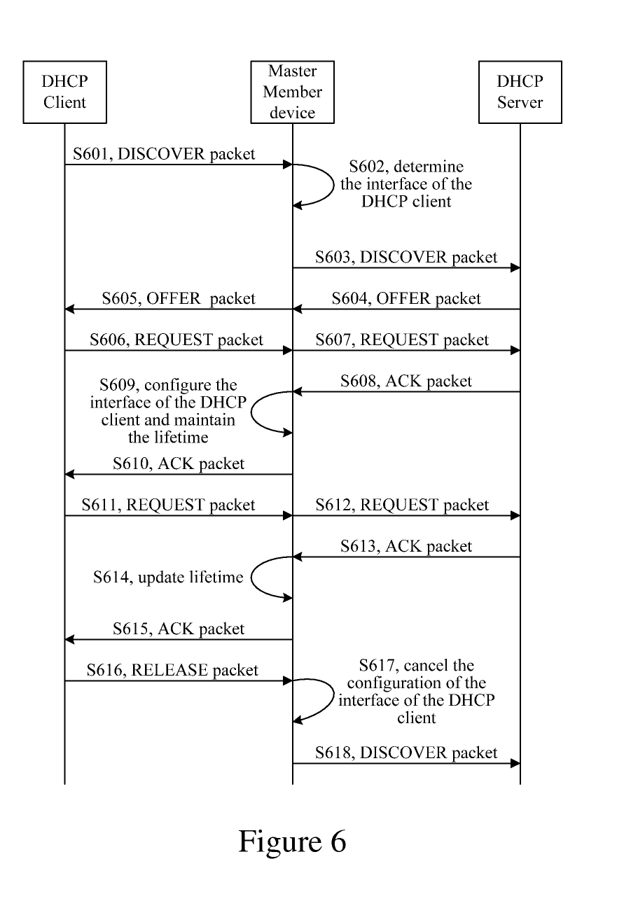

FIG. 6 is a schematic diagram illustrating two example of the present disclosure. In the example shown in FIG. 6, the first DHCP packet is the broadcasted DISCOVER packet, the second DHCP packet is the broadcasted or unicasted ACK packet, and the third DHCP packet is the unicasted RELEASE packet. As shown in FIG. 6, the method includes the following operations.

In block S601, after accessing to a local area network, a DHCP client broadcasts a DISCOVER packet in the local area network.

In block S602, in a VRRP backup group, a member device in a Master state snoops the DISCOVER packet, and determines an interface snooping the DISCOVER packet as an interface of the DHCP client.

In block S603, the member device in the Master state forwards the DISCOVER packet to a DHCP server.

In block S604, the DHCP server sends an OFFER packet to the DHCP client as a response to the DISCOVER packet.

In block S605, the member device in the Master state snoops the OFFER packet. Because the DHCP client does not decide whether to use a default gateway address and a subnet mask assigned by the DHCP server sending the OFFER packet, the member device in the Master state only forwards the snooped OFFER packet via the interface of the DHCP client without processing the snooped OFFER packet.

If only one DHCP server is configured in the networking, in block S605, a virtual IP address and a network segment route may be generated according to a default gateway address and a subnet mask carried in the snooped OFFER packet, and then the virtual IP address and network segment route are configured for the interface of the DHCP client. In addition, the member device may also establish and begin to maintain a lease length of the virtual IP address and network segment route configured for the interface of the DHCP client according to a lifetime carried in the snooped OFFER packet, i.e. the second DHCP packet may be the OFFER packet.

In block S606, the DHCP client selects one DHCP server from all DHCP servers sending the OFFER packet, and broadcasts a REQUEST packet in the local area network so as to notify all DHCP servers of the selected DHCP server.

In block S607, the member device in the Master state snoops the broadcasted REQUEST packet. Because the interface of the DHCP client has been determined in block S601, it is unnecessary to perform the interface location again, and the snooped REQUEST packet is forwarded to the DHCP server.

If the interface of the DHCP client is not determined in S601, in block S607, an interface snooping the REQUEST packet may be determined as the interface of the DHCP client, i.e. the first DHCP packet may be the broadcasted REQUEST packet.

In block S608, the DHCP server determines that the DHCP client has selected the DHCP server after receiving the REQUEST packet, and broadcasts an ACK packet to the DHCP client, the ACK packet carries a MAC address of the DHCP client.

In block S609, the member device in the Master state snoops the broadcasted ACK packet. Because the DHCP client has decided to use the default gateway address and subnet mask assigned by the DHCP server sending the ACK packet, the member device in the Master state configures the virtual IP address and the network segment route for the interface of the DHCP client according to the default gateway address and subnet mask carried in the ACK packet. The member device in the Master state also establishes and maintains a lifetime of the virtual IP address and network segment route configured for the interface of the DHCP client, according to a lease length carried in the ACK packet.

In block S610, the member device in the Master state forwards the snooped ACK packet via the interface of the DHCP client.

In block S611, before the lease length of the default gateway address and subnet mask assigned by the DHCP server is about to expire, the DHCP client unicasts a REQUEST packet to the DHCP server assigning the default gateway address and the subnet mask, so as to apply for renewal of the lease length.

In block S612, the member device in the Master state snoops the unicasted REQUEST packet, and forwards the snooped REQUEST packet to the DHCP server.

In block S613, the DHCP server unicasts an ACK packet for allowing the renewal after receiving the REQUEST packet for applying the renewal.

In block S614, the member device in the Master state snoops the ACK packet. Because the interface of the DHCP client has been configured with the virtual IP address and the network segment route, and the lifetime is configured, the member device in the Master state also updates the lifetime of the virtual IP address and the network segment route configured for the interface of the DHCP client.

In block S615, the member device in the Master state forwards the ACK packet via the interface of the DHCP client.

In block S616, when the DHCP client no longer needs the default gateway address and the subnet mask assigned by the DHCP server, the DHCP client unicasts a RELEASE packet to the DHCP server assigning the default gateway address and the subnet mask to release the lease.

In block S617, the member device in the Master state snoops the RELEASE packet, cancels the interface snooping the RELEASE packet, i.e., cancels the virtual IP address and the network segment route configured for the interface of the DHCP client.

In block S618, the member device in the Master state forwards the RELEASE packet via the interface of the DHCP client.

If the DECLINE packet unicasted by the DHCP client is snooped just after block S610, the member device in the Master state may perform the same operations in S617 and S618, that is, the third DHCP packet may also be the DECLINE packet. Or, if the DHCP client does not perform the renewal after block S610, when the lifetime expires, the member device in the Master state cancels the virtual IP address and the network segment route.

In the example shown in FIG. 6, when the DHCP server and the VRRP backup group are located at the same local area network as shown in FIG. 1a, the operations in S603, S604, S607, S608, S612, and S613 are performed directly.

When the DHCP server and the VRRP backup group are located at different local area networks as shown in FIG. 1b, a DHCP Relay function of the DHCP server needs be started when the operations in S603, S604, S607, S608, S612, S613 are performed. In addition, no matter whether the DHCP packet is unicasted or broadcasted, after receiving the DHCP packet, the member device with the started DHCP Relay function forwards the DHCP packet to the DHCP server via a unicast mode preferably. Further, when snooping the unicasted DHCP packet, the member device in the Backup state forwards the snooped DHCP packet to the member device in the Master state for further processing.

The foregoing are only preferred examples of the present disclosure and are not for use in limiting the protection scope of the present disclosure. Any modification, equivalent replacement and improvement made within the scope of the present disclosure should be covered under the protection scope of the present disclosure.

1. A method for configuring a Virtual Router Redundancy Protocol (VRRP) backup group, when a member device is in a Master state in a VRRP backup group, comprising:
after snooping a first Dynamic Host Configuration Protocol (DHCP) packet sent from a DHCP client to a DHCP server, determining, by the member device in the Master state, an interface receiving the first DHCP packet as an interface of the DHCP client;
after snooping a second DHCP packet sent from the DHCP server to a DHCP client, obtaining, by the member device in the Master state, a default gateway address and a subnet mask of the DHCP client from the second DHCP packet; and
after obtaining the default gateway address and the subnet mask of the DHCP client, if it is determined that the interface of the DHCP client is not configured with a virtual IP address and a network segment route, respectively configuring, by the member device in the Master state, the default gateway address and the subnet mask as the virtual IP address and the network segment route on the interface of the DHCP client.

2. The method of claim 1, further comprising:
after snooping the second DHCP packet sent from the DHCP server to the DHCP client, obtaining, by the member device in the Master state, a lease length from the second DHCP packet;
after obtaining the default gateway address; the subnet mask and the lease length of the DHCP client, establishing, by the member device in the Master state, a lifetime for the virtual IP address and network segment route configured for the interface of the DHCP client according to the obtained lease length, if no lifetime is configured for the virtual IP address and network segment route; or
maintaining, by the member device in the Master state, a lifetime for the virtual IP address and network segment route configured for the interface of the DHCP client according to the obtained lease length, if the lifetime is configured for the virtual IP address and network segment route; and
after the lifetime of the virtual IP address and the network segment route expires, cancelling, by the member device in the Master state, the virtual IP address and the network segment route;
or after the member device in the Master state snoops via the interface a third DHCP packet sent to the DHCP server by each of the DHCP clients using the same virtual IP address and network segment route has sent, cancelling, by the member device in the Master state, the virtual IP address and the network segment route.

3. The method of claim 2, further comprising:
after obtaining the default gateway address, the subnet mask and the lease length of the DHCP client, storing the lease length of the DHCP client, storing that the DHCP client is in a logoff state when the lease length expires and no renewal is performed; or storing that the DHCP client is in a logoff state when the third DHCP packet sent to the DHCP server from the DHCP client is snooped; and
if it is determined that all of the DHCP clients using the same virtual IP address and network segment route are in the logoff state, cancelling the virtual IP address and network segment route.

4. The method of claim 2, when the member device is in a Backup state in a VRRP backup group, further comprising:
after snooping the first, second or third DHCP packet, forwarding, by the member device in the Backup state, the first, second or third DHCP packet to the member device in the Master state in the VRRP backup group.

5. The method of claim 2, further comprising:
notifying, by the member device in the Master state, other member devices in a Backup state of the virtual IP address and network segment route configured for the interface of each DHCP client and the lifetime maintained for each DHCP client.

6. The method of claim 2, wherein
the first DHCP packet is a DISCOVER packet or a REQUEST packet;
the second DHCP packet is an ACK packet;
the third DHCP packet is a DECLINE packet or a RELEASE packet.

7. An apparatus for configuring Virtual Router Redundancy Protocol (VRRP) backup group, comprising an interface, a memory and a processor, wherein when the apparatus is located in a member device in a Master state in a VRRP backup group,
the interface is to snoop a first Dynamic Host Configuration Protocol (DHCP) packet sent from a DHCP client to a DHCP server and snoop a second DHCP packet sent from a DHCP server to a DHCP client;
the memory is to determine an interface receiving the first DHCP packet as an interface of the DHCP client, and store a default gateway address and a subnet mask of the DHCP client, the default gateway address and the subnet mask are obtained from the second DHCP packet; and
the processor is to determine whether the interface of the DHCP client is configured with a virtual IP address and a network segment route, and configure the default gateway address and the subnet mask as the virtual IP address and the network segment route on the interface of the DHCP client when the interface of the DHCP client is not configured with a virtual IP address and a network segment route.

8. The apparatus of claim 7, wherein
the memory is further to store a lease length of the DHCP client obtained from the second DHCP packet after the second DHCP packet is snooped;
the processor is further to establish a lifetime for the virtual IP address and network segment route configured for the interface of the DHCP client according to the lease length, if no lifetime is configured for the virtual IP address and network segment route; or to maintain a lifetime for the virtual IP address and network segment route configured for the interface of the DHCP client according to the lease length, if the lifetime is configured for the virtual IP address and network segment route; and
the processor is further to cancel the virtual IP address and the network segment route after the lifetime of the virtual IP address and the network segment route expires; or to cancel the virtual IP address and the network segment route after the member device in the Master state snoops via the interface that each of the DHCP clients using the same virtual IP address and network segment route has sent a third DHCP packet to the DHCP server.

9. The apparatus of claim 8, wherein
the memory is further to, after the default gateway address, the subnet mask and the lease length of the DHCP client are obtained, store the lease length of the DHCP client, store that the DHCP client is in a logoff state when the lease length expires and no renewal is performed; or store that the DHCP client is in a logoff state when the third DHCP packet sent to the DHCP server from the DHCP client is snooped by the member device in the Master state; and
the processor is further to cancel the virtual IP address and network segment route when it is determined that all of the DHCP clients using the same virtual IP address and network segment route are in the logoff state.

10. The apparatus of claim 8, wherein when the apparatus is located in a member device in a Backup state in the VRRP backup group, and
the processor is further to forward the first, second or third DHCP packet to the member device in the Master state in the VRRP backup group, when snooping the first, second or third DHCP packet.

11. The apparatus of claim 8, wherein
the processor is further to notify other member devices in a Backup state of the virtual IP address and network segment route configured for the interface of each DHCP client and the lifetime maintained for each DHCP client.

12. The apparatus of claim 8, wherein:
the first DHCP packet is a DISCOVER packet or a REQUEST packet;
the second DHCP packet is an ACK packet; and
the third DHCP packet is a DECLINE packet or a RELEASE packet.
